(19) United States
(12) Patent Application Publication
(10) Pub. No.: US 2011/0145620 A1
(43) Pub. Date: Jun. 16, 2011

(54) METHOD OF USING POWER SUPPLY TO PERFORM FAR-END MONITORING OF ELECTRONIC SYSTEM

(76) Inventors: Tsun-Te SHIH, Taipei Hsien (TW); Yu-Yuan Chang, Taipei Hsien (TW); Yi-Hua Wang, Taipei Hsien (TW); Yu-Lung Huang, Taipei Hsien (TW); Chia-Lun Liu, Taipei Hsien (TW); Tsung-Chun Chen, Taipei Hsien (TW)

(21) Appl. No.: 12/638,483

(22) Filed: Dec. 15, 2009

(51) Int. Cl. G06F 1/28

(52) U.S. Cl. 713/340

(57) ABSTRACT

The present invention discloses a method of using a power supply to perform far-end monitoring of an electronic system. The electronic system has at least one power supply. The power supply has a signal integration unit receiving working parameters of the electronic system and a communication unit transmitting the working parameters to a communication network. The method of the present invention comprises steps: setting warning conditions, collecting working parameters, performing judgment, and performing far-end warning. The warning conditions are defined and stored in the signal integration unit. The signal integration unit collects the working parameters of the electronic system persistently. When determining that at least one of the working parameter meets the warning conditions, the signal integration unit generates a warning signal. The communication unit receives the warning signal and transmits the warning signal to the communication network.

### FIELD OF THE INVENTION

The present invention relates to a method of using a power supply to perform far-end monitoring of an electronic system, particularly to a method of using a power supply to perform detection and provide malfunction warning independently.

### BACKGROUND OF THE INVENTION

Refer to FIG. 1 a block diagram schematically showing a conventional monitoring system of a multi-power supply device, which applies to a server or a UPS (Uninterruptible Power Supply) system. The multi-power supply device includes a plurality of power supplies 91, which may be arranged in a single chassis, or respectively arranged in several chassis, or even respectively located in several different positions. The power supplies 91 are respectively connected to loads but jointly connected to a data processing system 92. The data processing system 92 may be a bus backplane inside the chassis or a computer connected to the power supplies 91 via cables. The data processing system 92 is powered by the power supplies 91. The data processing system 92 receives the information of the outputs and abnormal states of the power supplies 92 and transmits the information to a far-end monitoring device 93, whereby the administrator can learn the operation statuses of the power supplies 91 (for example, the breakdown of one power supply 91) even though he is not beside the power supplies 91.

The abovementioned architecture has prevailed for many years. However, crashes or data loss that are caused by the malfunction of a power supply 91 still occur sometimes because of the drawbacks of the abovementioned architecture. The conventional power supply 91 transmits data to the data processing system 92 (a bus backplane or a motherboard of a computer) via an I²C circuit, and then the data processing system 2 interprets the data and transmits information to the far-end monitoring device 93. However, some data processing systems 92 (such as motherboards of some computers) do not support I²C. Thus, the conventional power-supply monitoring system cannot apply to all the power supplies.

Further, the I²C address designation of the data processing system 92 may mismatch that of the power supply 91, which will generate wrong data. For example, the I²C address 0x25 is used to transmit the temperature of the CPU of a computer originally but is designated to transmit the internal temperature of the power supply 91 in the power-supply side. Different address designations in two sides result in that the data processing system 92 reads wrong data and that the administrator cannot learn the real statuses of the power supplies 91.

Furthermore, the data processing system 92 itself may crash and thus cannot read data from the I²C circuit. In such a case, the administrator cannot get correct information from the far-end monitoring device 93 no matter whether the power supply 91 is normal or abnormal.

Moreover, when the power supply 91 malfunctions, the data processing system 92 powered by the power supply 92 cannot work also. Then, the far-end monitoring device 93 cannot get data to determine whether the malfunction occurs in the power supply 91 or the data processing system 92. Thus, repairing the malfunction will be laborious.

Before the malfunction causes the power supply 91 to completely shut down, there are usually some auguries appearing, such as the instability of voltage, the slowdown of the electric fan, or temperature rising, which may imply some indistinct problems, for example, capacitor damage, short-circuit, or too much dust accumulated, etc. In the conventional technology, instable voltage may cause the crash of the data processing system 92. In such a case, it is a corollary that the far-end monitoring device 93 cannot receive information from the data processing system 92. Even though the data processing system 92 is rebooted, it is not necessarily that the problem can be found immediately.

Therefore, the conventional power-supply monitoring system has many problems in application and thus has much room to improve.

### SUMMARY OF THE INVENTION

One objective of the present invention is to provide a method of using a power supply to transmit working parameters and perform monitoring, which includes a mechanism to determine whether there is an abnormal condition so as to warn an administrator, whereby the administrator can acquire the statuses of apparatuses of the electronic system.

The present invention proposes a method of using a power supply to perform far-end monitoring of an electronic system. The electronic system has at least one power supply. The power supply comprises a signal integration unit receiving the working parameters of the electronic system and a communication unit transmitting the working parameters to a communication network. The method of the present invention comprises steps: a step of setting warning conditions, a step of collecting working parameters, a step of performing judgment, and a step of performing far-end warning. In the step of setting warning conditions, the warning conditions are defined and stored in the signal integration unit. In the step of collecting working parameters, the signal integration unit normally collects the working parameters of the electronic system. In the step of performing judgment, the signal integration unit generates a warning signal when it determines that at least one of the working parameters meets the warning conditions. In the step of performing far-end warning, the communication unit receives the warning signal and transmits the warning signal to the communication network. The method of the present invention not only can transmit a warning signal in the abnormal condition but also can normally transmit the working parameters to the communication network. Thereby, the administrator can read the working parameters via the communication network and learn the source of a malfunction in the abnormal condition. Therefore, the administrator can easily maintain the system.

### BRIEF DESCRIPTION OF THE DRAWINGS

FIG. 1 is a block diagram schematically showing the architecture of a conventional monitoring circuit;

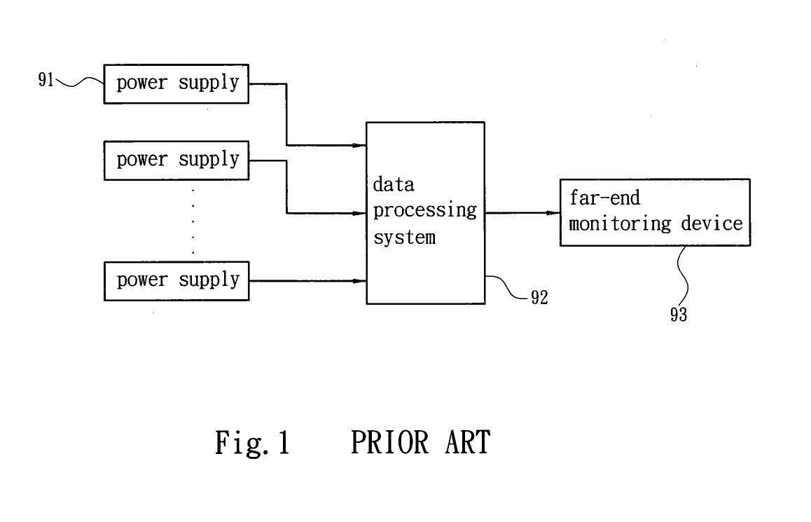

FIG. 2 is a flowchart of a method according to the present invention;

FIG. 3 is a block diagram schematically showing the architecture according to one embodiment of the present invention;

FIG. 4 is a block diagram schematically showing the architecture according to another embodiment of the present invention; and

FIG. 5 is a block diagram schematically showing the detailed architecture shown in FIG. 3.

### DETAILED DESCRIPTION OF THE PREFERRED EMBODIMENTS

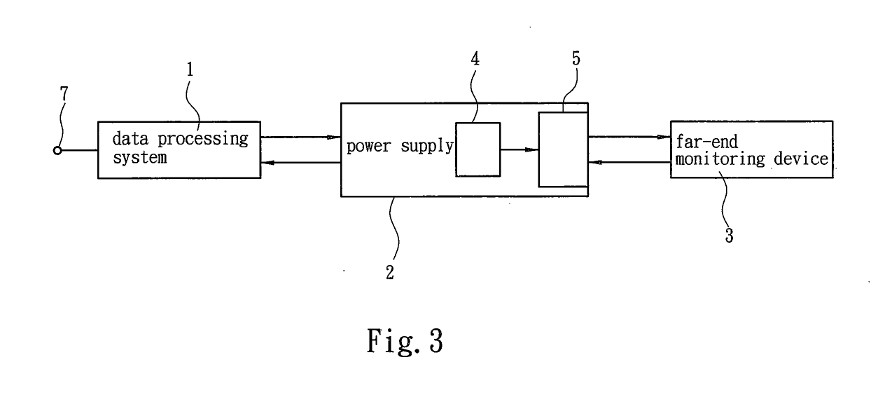

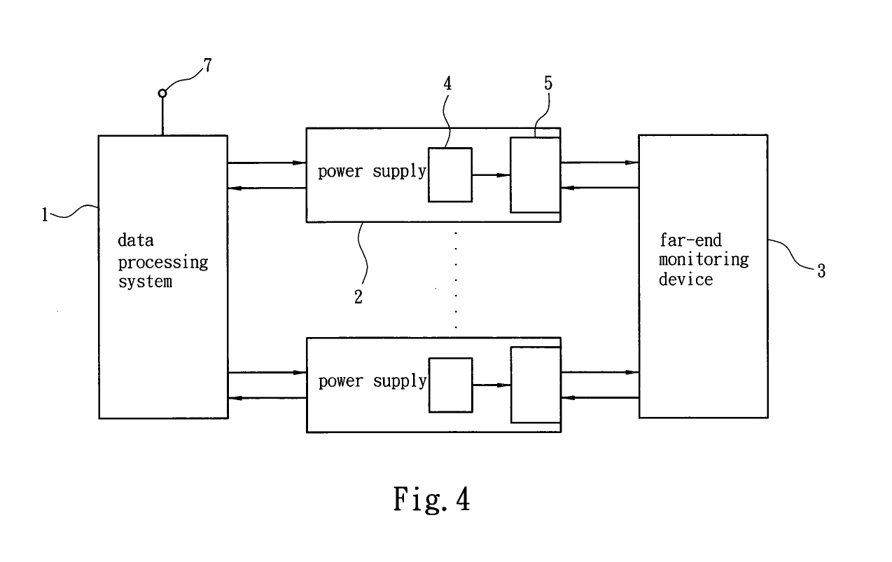

The present invention provides a method of using a power supply to perform far-end monitoring of an electronic system. The electronic system has a single power supply 2 (as shown in FIG. 3) or a plurality of power supplies 2 (as shown in FIG. 4). Refer to FIG. 3 firstly. The electronic system in FIG. 3 has a data processing system 1 and the power supply 2. The data processing system 1 is controlled by a trigger 7 to output a power on/off signal to switch the power supply 2 into a working mode or a sleep mode. The power supply 2 comprises a signal integration unit 4 collecting the working parameters of the electronic system and a communication unit 5 transmitting the working parameters to a communication network. The working parameters may include an output voltage of the power supply 2, an output current of the power supply 2, an internal temperature of the power supply 2 and a rotation speed of an electric fan of the power supply 2. The working parameters may also include an on/off state of the data processing system 1. The signal integration unit 4 determines whether the working parameters are normal or not to generate a warning signal when one of the working parameters is abnormal. The communication unit 5 transmits the warning signal to the communication network. The administrator receives the warning signal from a far-end monitoring device 3 and acquires an abnormal state of the electronic system. In one embodiment, the data processing system 1 is a motherboard of a computer, and the power supply 2 provides power for the computer, and the far-end monitoring device 3 monitors the status of the electronic system.

Refer to FIG. 4. The data processing system 1 in FIG. 4 is connected to the power supplies 2. Each power supply 2 comprises the signal integration unit 4 and the communication unit 5. The data processing system 1 is controlled by the trigger 7 to output the power on/off signals to switch the power supplies 2 into the working mode or the sleep mode. The signal integration units 4 collect working parameters and determine whether to generate the warning signal according to the working parameters. The communication units 5 transmit the warning signal to the communication networks. Similarly, the working parameters may also include the on/off state of the data processing system 1. The far-end monitoring device 3 receives the warning signal from the communication networks. In one embodiment, the data processing system 1 is a bus backplane.

In the embodiments of FIG. 3 and FIG. 4, the signal integration unit 4 can normally transmit the working parameters to the communication network via the communication unit 5, whereby the administrator can normally monitor the working parameters collected by the signal integration unit 4 via the far-end monitoring device 3.

To achieve the abovementioned functions, the method of the present invention controls the power supply 2 (comprising the signal integration unit 4 and the communication unit 5) to perform the following steps:

A. A step of setting warning conditions, wherein warning conditions are defined and stored in the signal integration unit 4;

B. A step of collecting working parameters, wherein the signal integration unit 4 normally collects the working parameters of the electronic system;

C. A step of performing judgment, wherein the signal integration unit 4 generates the warning signal when the signal integration unit 4 determines that at least one of the working parameters meets the warning conditions;

D. A step of performing far-end warning, wherein the communication unit 5 receives the warning signal and transmits the warning signal to a communication network.

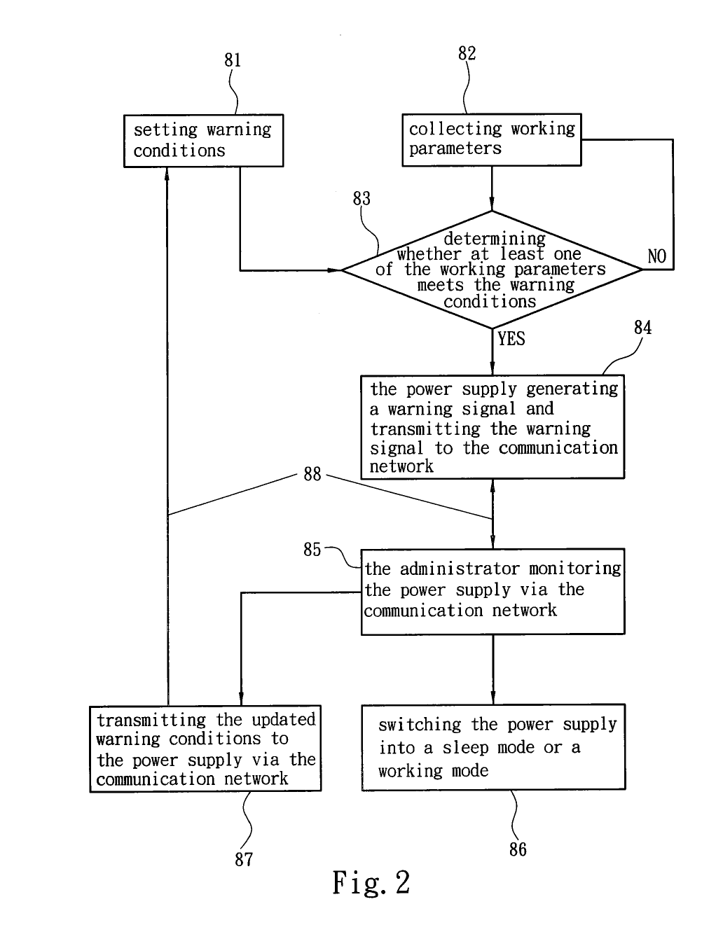

Refer to FIG. 2 a flowchart of the abovementioned steps. Before the signal integration unit 4 performs judgment, the warning conditions are set beforehand (Step 81). When the signal integration unit 4 starts to work, it normally collects the working parameters (Step 82) and then determines whether at least one of the working parameters meets the warning conditions (Step 83). If the working parameters do not meet the warning conditions, it means that the electronic system operates normally. If at least one of the working parameters meets the warning conditions correspondingly, it means that some portion of the electronic system is abnormal. Thus, the signal integration unit 4 generates the warning signal and transmits the warning signal to a communication network 88 via the communication unit 5 (Step 84). The circuits shown in FIG. 3 and FIG. 4 may realize the method of the present invention according to the flowchart. The working parameters are selected from the group consisting of the output voltage of the power supply 2, the output current of the power supply 2, the internal temperature of the power supply 2 and the rotation speed of the electric fan of the power supply 2. One of the warning conditions may be an upper limit of one of the working parameters, a lower limit of one of the working parameters or a combination of the upper limit and the lower limit of one of the working parameters. The warning conditions may also be the upper limit of the variation of one of the working parameters. When the variation exceeds the upper limit (for example, the variation of the output voltage is too large), the electronic system is regarded as unstable, and the warning signal is sent out. The working parameters may also include the on/off state of the data processing system 1. When the power supply 2 is working, the data processing system 1 should be working also. Therefore, the warning conditions also include the case that the data processing system 1 is abnormally interrupted during the working mode of the power supply 2.

Refer to FIG. 2 again. After the power supply 2 sends the warning signal to the communication network 88, the administrator receives the warning signal from the communication network 88 to monitor the power supply 2 (Step 85). After the administrator receives the warning signal, he determines whether to switch the power supply 2 into the sleep mode or the working mode according to the warning signal (Step 86). The administrator may transmit updated warning conditions to the power supply 2 via the communication network 88 (Step 87). The communication unit 5 receives the updated warning conditions and transmits the updated warning conditions to the signal integration unit 4.

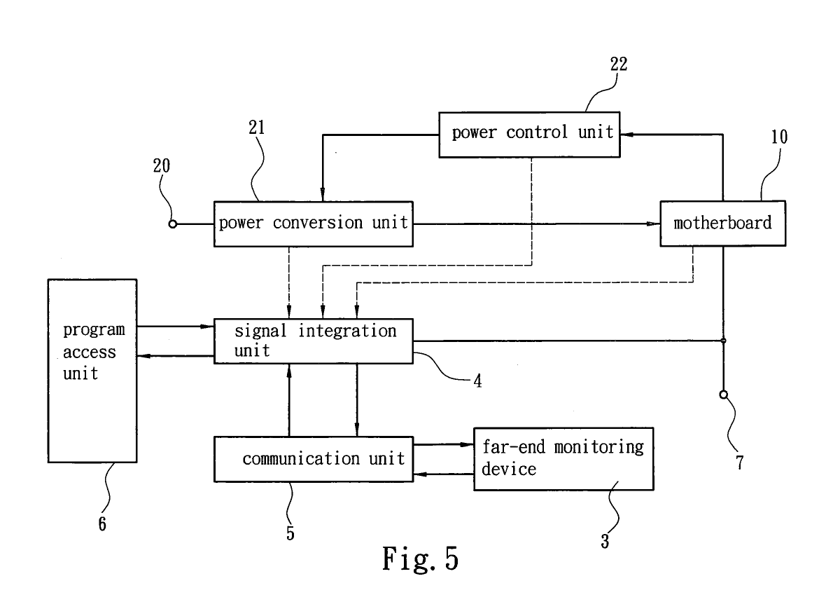

Refer to FIG. 5 for the detailed description of one embodiment of the present invention. The power supply 2 also comprises an input terminal 20, a power conversion unit 21 and a power control unit 22. In this embodiment, the data processing system 1 is a motherboard 10 of a computer. The motherboard 10 is connected to the trigger 7. The administrator operates the trigger 7 to make the motherboard 10 switch the operation mode of the power supply 2. If the power supply 2 is originally in the sleep mode, the administrator can operate the trigger 7 to make the motherboard 10 send the power on/off signal to the power control unit 22 of the power supply 2. Then, the power control unit 22 starts the power conversion unit 21 to output power. The power control unit 22 controls a power-on time of the power supply 2 and detects the output voltage, the output current, the internal temperature and the rotation speed of the electric fan. The technology that the power control unit 22 performs the abovementioned functions is a prior art familiar to a person skilled in the art. Therefore, it is not shown in the drawings. From the power conversion unit 21 or the power control unit 22, the signal integration unit 4 may obtain the output voltage, output current, internal temperature or the rotation speed of the electric fan as the working parameters. The signal integration unit 4 may further obtain a state signal represented the on/off state of the motherboard 10. Then, the communication unit 5 transmits the working parameters obtained by the signal integration unit 4 to the far-end monitoring device 3 where the states of the data processing system 1 and the power supply 2 can be presented. Further, the signal integration unit 4 may connect with a program access unit 6 containing a programmed human-machine interface. The signal integration unit 4 reads the human-machine interface, integrates the human-machine interface and the working parameters, and sends them to the far-end monitoring device 3 via the communication unit 5. Thus, the far-end monitoring device 3 can read the human-machine interface and the working parameters.

In the conventional monitoring technology, the working parameters are sent to the data processing unit 1 before they are transmitted to the far end. However, the present invention does not send the working parameters to the data processing system 1, but collects the working parameters inside the power supply 2 and directly transmits the working parameters from the power supply 2 to the far end via the communication network 88. Even when the main output is unstable or interrupted or the data processing system 1 crashes, the signal integration unit 4 of the present invention can still collects the working parameters and transmits them to the far-end monitoring device 3. Therefore, the present invention can overcome the problems of the conventional technology. Via executing the method of the present invention, the power supply 2 generates the warning signal to remind the administrator to maintain the system or enhance the monitoring of the electronic system. Each power supply 2 has its maintenance period or service life. The signal integration unit 4 may further has a timer circuit, whereby the signal integration unit 4 will send a maintenance signal after a predetermined duration to the administrator to remind him to perform a periodical maintenance or replacement before expiring. The communication network 88 between the communication unit 5 and the far-end monitoring device 3 may be a physical wire network, a wireless network or a combination of both. The present invention will not limit the communication format between the communication unit 5 and the far-end monitoring device 3 as long as the communication format can effectively implement the transmission task of the working parameters.

The embodiments described above are only to exemplify the present invention but not to limit the scope of the present invention. Any equivalent modification or variation according to the spirit of the present invention is to be also included within the scope of the present invention, which is based on the claims stated below.

From the specification, it is known that the present invention has improvements over the conventional technology. Therefore, the present invention possesses utility, novelty and non-obviousness and meets the condition for a patent. Thus, the Inventor files the application for a patent. It will be appreciated if the patent is approved fast.

What is claimed is:

1. A method of using a power supply to perform far-end monitoring of an electronic system, wherein the electronic system has at least one power supply providing power, and wherein the power supply comprises a signal integration unit receiving working parameters of the electronic system and a communication unit transmitting the working parameters to a communication network, and wherein the method comprises
a step of setting warning conditions, wherein the warning conditions are defined and stored in the signal integration unit;
a step of collecting working parameters, wherein the signal integration unit normally collects the working parameters of the electronic system;
a step of performing judgment, wherein the signal integration unit generates a warning signal when the signal integration unit determines that at least one of the working parameters meets the warning conditions; and
a step of performing far-end warning, wherein the communication unit receives the warning signal and transmits the warning signal to the communication network.

2. The method of using a power supply to perform far-end monitoring of an electronic system according to claim 1, wherein the working parameters are selected from the group consisting of an output voltage of the power supply, an output current of the power supply, an internal temperature of the power supply, and a rotation speed of an electric fan of the power supply.

3. The method of using a power supply to perform far-end monitoring of an electronic system according to claim 2, wherein one of the warning conditions is an upper limit of one of the working parameters.

4. The method of using a power supply to perform far-end monitoring of an electronic system according to claim 2, wherein one of the warning conditions is a lower limit of one of the working parameters.

5. The method of using a power supply to perform far-end monitoring of an electronic system according to claim 2, wherein one of the warning conditions is a combination of an upper limit and a lower limit of one of the working parameters.

6. The method of using a power supply to perform far-end monitoring of an electronic system according to claim 2, wherein one of the warning conditions is an upper limit of variation of one of the working parameters.

7. The method of using a power supply to perform far-end monitoring of an electronic system according to claim 2, wherein the electronic system further has a data processing system, and wherein the data processing system outputs a power on/off signal to drive the power supply to switch into a working mode or a sleep mode, and wherein the working parameters further include an on/off state of the data processing system.

8. The method of using a power supply to perform far-end monitoring of an electronic system according to claim 7, wherein the warning conditions include a case: the data processing system is abnormally interrupted during the working mode of the power supply.

9. The method of using a power supply to perform far-end monitoring of an electronic system according to claim 1, wherein the communication unit exchanges signals with a far-end monitoring device via the communication network, and wherein the communication unit receives updated warning conditions from the far-end monitoring device and sends the updated warning conditions to the signal integration unit to perform the step of setting warning conditions.

10. The method of using a power supply to perform far-end monitoring of an electronic system according to claim 1, wherein the communication network is a physical wire network.

11. The method of using a power supply to perform far-end monitoring of an electronic system according to claim 1, wherein the communication network is a wireless network.

12. The method of using a power supply to perform far-end monitoring of an electronic system according to claim 1, wherein the communication network is a combination of a physical wire network and a wireless network.

13. The method of using a power supply to perform far-end monitoring of an electronic system according to claim 1, wherein the signal integration unit normally collects the working parameters and transmits the working parameters to the communication network via the communication unit.

14. The method of using a power supply to perform far-end monitoring of an electronic system according to claim 1, wherein the signal integration unit has a built-in timer circuit, whereby the signal integration unit generates a maintenance signal to remind an administrator after a predetermined duration.
